(19) United States
(12) Patent Application Publication
(10) Pub. No.: US 2024/0059044 A1
(43) Pub. Date: Feb. 22, 2024

(54) HONEYCOMB CORE WITH S-SHAPED REINFORCED STRUCTURES

(71) Applicants: Dalian Jiaotong University, Dalian (CN); Dalian University of Technology, Dalian (CN)

(72) Inventors: Shanshan SHI, Dalian (CN); Zhi SUN, Dalian (CN); Xin ZHOU, Dalian (CN); Bingzhi CHEN, Dalian (CN); Yonghua LI, Dalian (CN); Yuedong WANG, Dalian (CN)

(73) Assignees: Dalian Jiaotong University, Dalian (CN); Dalian University of Technology, Dalian (CN)

(21) Appl. No.: 18/226,261

(22) Filed: Jul. 26, 2023

(30) Foreign Application Priority Data
Aug. 22, 2022 (CN) 202211002346.6

(51) Int. Cl. B32B 3/12; B32B 3/08

(52) U.S. Cl. CPC B32B 3/12; B32B 3/085; B32B 2250/40; B32B 2305/024; B32B 2305/08; B32B 2307/7376

(57) ABSTRACT

A honeycomb core with S-shaped reinforced structures includes multiple cylindrical unit cells arranged in a honeycomb shape and with a polygonal cross section, the cylindrical unit cells are divided into plain unit cells and S-shaped reinforced unit cells, an inner cavity of the plain unit cell is hollow, and the inner cavity of the S-shaped reinforced unit cell is equipped with an S-shaped reinforced structure, a cross section of the S-shaped reinforced structure is S-shaped and the inner cavity of the S-shaped reinforced unit cell is divided into two halves on average. This structure guides the load-transfer path effectively by controlling the rotation of S-shaped reinforced cells, it changes the position of plastic collapse in the structure, and finally changes the peak load of the core. Under different working conditions, the design of the arrangement of S-shaped reinforced structures can make the core produce different peak loads.

### CROSS REFERENCE TO THE RELATED APPLICATIONS

This application is based upon and claims priority to Chinese Patent Application No. 202211002346.6, filed on Aug. 22, 2022, the entire contents of which are incorporated herein by reference.

### TECHNICAL FIELD

The invention relates to the field of honeycomb core design technology, in particular to a honeycomb core with S-shaped reinforced structures.

### BACKGROUND ART

The honeycomb sandwich structure is a kind of multiphase material that combines high strength/high modulus panels with low density and functional honeycomb core. This structure can not only improve the material utilization rate greatly and reduce the structural quality but also improve the environmental damage resistance, vibration reduction, heat insulation, and sound insulation of sandwich structure effectively by a reasonable selection of the microstructure of honeycomb.

Due to the obvious difference in material properties between high strength/high modulus panels and honeycomb cores, local damage and interface delamination of honeycomb cores often occur, which limits the mechanical properties of honeycomb sandwich structures. At present, the design of 3D lattice cores that has received extensive attention has many problems, such as different constitutive materials of reinforcing structures and reinforced structures, its processes being too complicated, very high manufacturing costs, or inability to be put into industrial production.

### SUMMARY

The purpose of the invention is to provide a honeycomb core with S-shaped reinforced structures to improve the mechanical properties of the honeycomb sandwich structure.

In order to solve the above technical problems, the invention provides a honeycomb core with S-shaped reinforced structures, including multiple cylindrical unit cells arranged in a honeycomb shape and with a polygonal cross section, the cylindrical unit cells are divided into plain unit cells and S-shaped reinforced unit cells, the inner cavity of the plain unit cell is hollow, and the inner cavity of the S-shaped reinforced unit cell is equipped with an S-shaped reinforced structure, the cross section of the S-shaped reinforced structure is S-shaped and the inner cavity of the S-shaped reinforced unit cell is divided into two halves on average.

Preferably, the S-shaped reinforced unit cell is made by flattening two plain units through a pinch extrusion process.

Preferably, the S-shaped reinforced unit cell is fabricated by an integrated molding process.

Preferably, one plain unit cell is set between two S-shaped reinforced unit cells at least.

Preferably, the S-shaped reinforced unit cells are in multiple columns, and each column contains multiple S-shaped reinforced unit cells, the S-shaped reinforced structure of the S-shaped reinforced unit cells of the same column has the same S-shaped direction, and the S-shaped reinforced structure of the neighboring two columns has the same or opposite S-shaped direction.

Preferably, the number of S-shaped reinforced cells accounts for 10%-50% of the total number of cylindrical unit cells.

Preferably, the cross section of the cylindrical unit cell is hexagonal.

Preferably, the material of the column unit cell is metal, carbon fiber, or aramid paper.

Preferably, the diameter of the single column is 2 mm-26 mm, the wall thickness is 0.04 mm-0.1 mm, and the height is 2 mm-590 mm.

Preferably, the thickness of the S-shaped reinforced structure is twice the wall thickness of the cylinder unit cell.

The honeycomb core with S-shaped reinforced structures of the invention performs secondary processing on the plain honeycomb so that some cells in the honeycomb core become cells with S-shaped reinforced structures. This structure guides the load-transfer path effectively by controlling the rotation of S-shaped reinforced cells, it changes the position of plastic collapse in the structure, and finally changes the peak load of the core. Under different working conditions, the design of the arrangement of S-shaped reinforced structures can make the core produce different peak loads, the peak load of the honeycomb core with S-shaped reinforced structures has a designability that can meet different engineering application requirements. In addition, the failure mode of the original plain core is improved, the honeycomb core with S-shaped reinforced structure is destroyed column by column, so that the core can be controlled and orderly destroyed, and the failure mode of the original plain core is improved. When it is used as the core of the sandwich structure, the interface performance between the core and the panel can be improved, and the mechanical bearing performance of the honeycomb sandwich panel can be improved. When the honeycomb core with S-shaped reinforced structure is used as the core of the sandwich structure, the core can be controlled and orderly destroyed, thereby significantly improving the energy absorption performance of the sandwich panel, the honeycomb core with S-shaped reinforced structures is directly flattened based on the plain honeycomb core, which has low requirements for processing equipment, the processing technology is simple, the connection between the reinforced structure and the core after processing is good, and the structural defects are few.

### BRIEF DESCRIPTION OF THE DRAWINGS

FIG. 1 is a two-dimensional schematic diagram of the honeycomb core with S-shaped reinforced structures of the embodiment of the invention.

FIG. 2 is a three-dimensional schematic diagram of the honeycomb core with S-shaped reinforced structures of the embodiment of the invention.

FIG. 3 is a load transfer diagram of the honeycomb core with S-shaped reinforced structures of the embodiment of the invention.

FIG. 4 is a schematic diagram of a specimen of the honeycomb core with heterodromous S-shaped reinforced structures of the embodiment of the invention.

FIG. 5 is a schematic diagram of a specimen of the honeycomb core with homodromous S-shaped reinforced structures for the embodiment of the invention.

FIG. 6 is a load-displacement diagram of the honeycomb core with heterodromous S-shaped reinforced structures of the embodiment of the invention.

FIG. 7 is a load-displacement diagram of the honeycomb core with homodromous S-shaped reinforced structures of the embodiment of the invention.

Marks in the figures, 1: plain unit cell; 2: S-shaped reinforced unit cell; 3: S-shaped reinforced structure.

### DETAILED DESCRIPTION OF THE EMBODIMENTS

The following is a further detailed description of an implementation method of the invention in combination with the accompanying drawings and an embodiment. The following embodiment is used to illustrate the invention, but cannot be used to limit the scope of the invention.

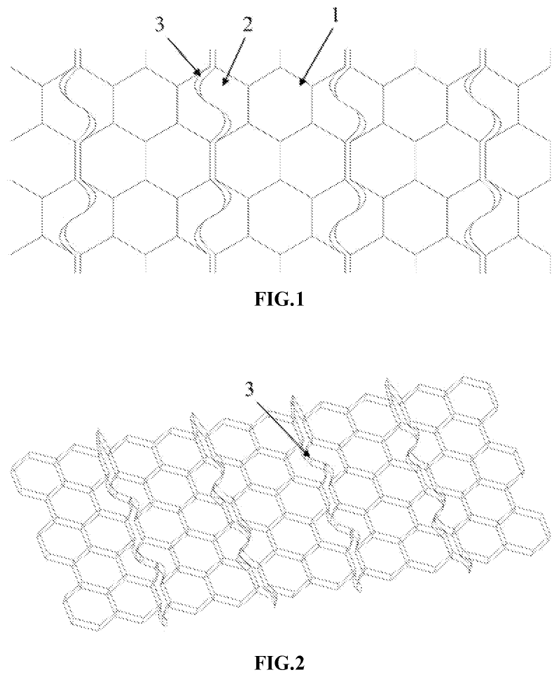

As shown in FIGS. 1-2, the honeycomb core with S-shaped reinforced structures in this embodiment includes: multiple cylindrical unit cells arranged in a honeycomb shape and with a polygonal cross section, the cylindrical unit cells can be cylindrical unit cells with the same size, or hierarchical cylindrical unit cells with different wall thickness, pore size, etc. the cylindrical unit cells are divided into plain unit cells 1 and S-shaped reinforced unit cells 2, the inner cavity of the plain unit cell 1 is hollow, and the inner cavity of the S-shaped reinforced unit cell 2 is equipped with an S-shaped reinforced structure 3, the cross section of the S-shaped reinforced structure 3 is S-shaped and the inner cavity of the S-shaped reinforced unit cell is divided into two halves on average.

The S-shaped reinforced unit cell 2 can be made by flattening two plain unit cells 1 through a pinch extrusion process, the thickness of the formed S-shaped reinforced structure 3 is usually twice the wall thickness. The S-shaped reinforced structure 3 formed by flattening the sidewalls of the two unit cells is shown in FIGS. 1, 2, 4, and 5. The two sidewalls of the S-shaped reinforced structure 3 should be fitted as much as possible, and the ideal state is completely fitted. However, due to the extrusion technology and other reasons, some gaps may be generated between the two sidewalls during the actual operation. The S-shaped reinforced unit cell 2 can also be made by an integrated molding process, the S-shaped reinforced structure 3 is a solid S-shaped wall structure in this case.

According to different design requirements, the minimum arrangement interval of the S-shaped reinforced structure 3 is a plain unit cell 1, and one plain unit cell 1 is set between two S-shaped reinforced unit cells 2 at least, and the maximum is not limited to the number of cells. The S-shaped reinforced unit cells 2 are in multiple columns, and each column contains multiple S-shaped reinforced unit cells 2, the S-shaped reinforced structure 3 of the S-shaped reinforced unit cells 2 of the same column has the same S-shaped direction, and the S-shaped reinforced structure 3 of the neighboring two columns has the same or opposite S-shaped direction. The direction of the S-shaped reinforced structure 3 can be a left-handed S-structure (the guided reinforced unit cell rotates counterclockwise when the core is loaded) or a right-handed S-structure (the guided reinforced unit cell rotates clockwise when the core is loaded). According to different design requirements, the direction of the reinforced structure in the honeycomb core with S-shaped reinforced structures 3 can be arranged arbitrarily to change the peak load and failure mode of the core. When the neighboring S-shaped reinforced structure 3 is closer to the heterodromous, the failure mode of the honeycomb core with S-shaped reinforced structures 3 is closer to a layer-by-layer failure, when the neighboring S-shaped reinforced structure 3 is closer to the same direction, the failure mode of the honeycomb core with S-shaped reinforced structures 3 is closer to the overall shear failure, and the peak load can be designed within a certain threshold. The specimen of the honeycomb core with heterodromous S-shaped reinforced structures is shown in FIG. 4, and the specimen of the honeycomb core with homodromous S-shaped reinforced structures is shown in FIG. 5. Part of the honeycomb unit cells in the plain aluminum honeycomb core is processed by the pinch extrusion process to form 8 S-shaped reinforced honeycomb structures.

In this embodiment, the cross section of the cylinder unit cell is hexagonal, the material is 5052 aluminum alloy, and can also be other metal materials, carbon fiber materials, or aramid paper materials. The pore size of the cylinder unit cell is 2 mm-26 mm, the wall thickness is 0.04 mm-0.1 mm, usually no more than 5% of the pore size of the honeycomb core, the height is 2 mm-590 mm, preferably, the pore size is 6 mm, the wall thickness is 0.06 mm, the height is 20 mm, the honeycomb core specimen is 150 mm long and 100 mm wide. The thickness of the S-shaped reinforced structure 3 is about twice the wall thickness of the cylinder unit cell. The number of S-shaped reinforced unit cells 2 accounts for 10%-50% of the total number of column cells, and preferably 47%.

The honeycomb core with S-shaped reinforced structures can be combined with the panel by hot pressing, bonding, or welding when it is used as the core of the sandwich structure, the panel includes a metal panel, polymer panel, and fiber reinforced composite panel.

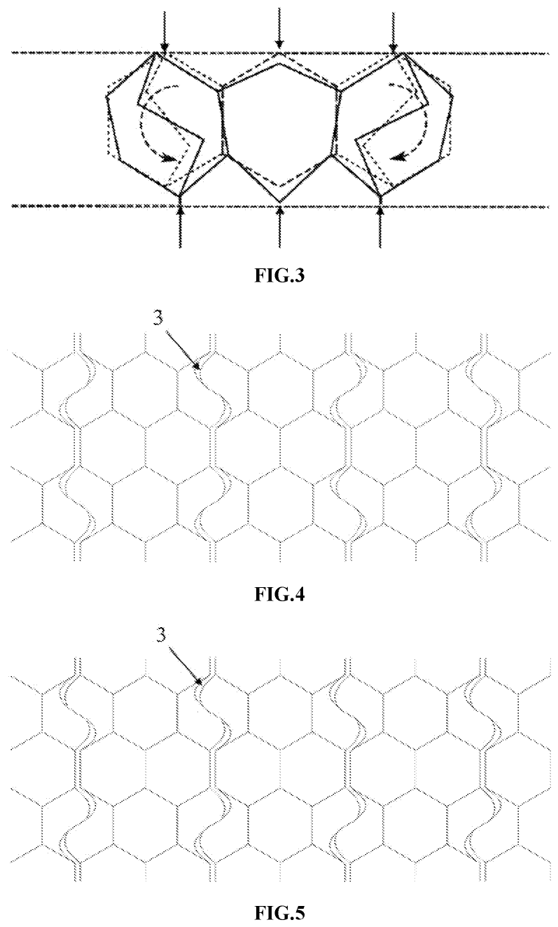

The working principle and working process of this embodiment: when the core is subjected to in-plane compression load in the same direction as the S-shaped reinforced structure, the load is transmitted between the honeycomb cells through the honeycomb wall. When transmitted to the S-shaped reinforced honeycomb unit cell, the load flattens the honeycomb unit cell wall while flattening the S-shaped reinforced structure. As the load increases, the S-shaped reinforced structure rotates, guiding the entire unit cell with S-shaped reinforcement to rotate, and stretching the honeycomb wall of the unreinforced unit cell, as shown in FIG. 3. This load transfer process can effectively optimize the load-transfer path and change the core failure mode, thereby changing the peak load of the core.

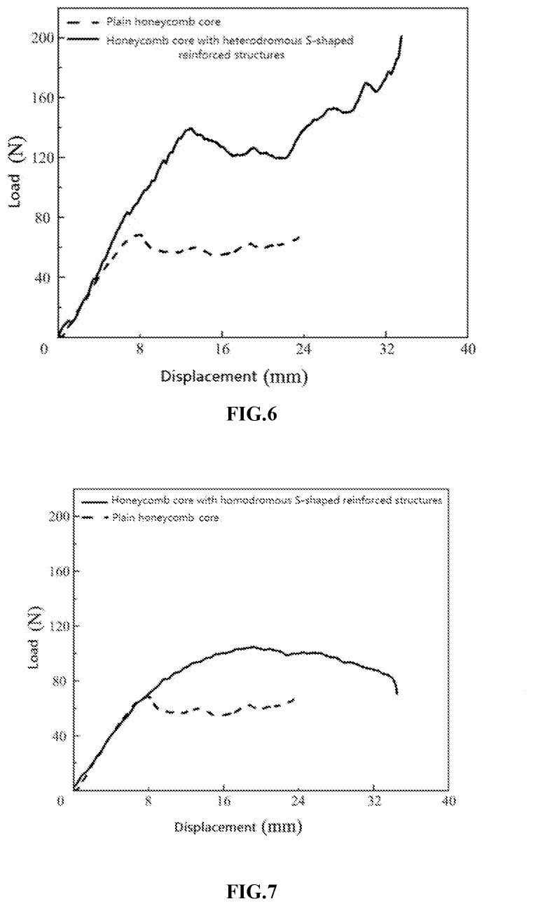

The load-displacement curves of plain honeycomb core, honeycomb core with heterodromous S-shaped reinforced structures, and honeycomb core with homodromous S-shaped reinforced structure are shown in FIGS. 6-7. The results show that in the initial loading stage, the compressive stiffness of the specimen of the honeycomb core specimen with heterodromous S-shaped reinforcement is higher than that of the specimen of the plain honeycomb core. In the failure mode, the specimen of the plain honeycomb core exhibits uniform deformation in the linear elastic stage. When the load exceeds the ultimate load of the core, the deformation in the specimen begins to localize. In the deformation region, the cavity collapses in an asymmetric shear deformation mode, while the deformation far away from the region remains symmetrical and uniform. With the increase of load, the collapse deformation area expands to both ends. The unit cells between the two reinforced structures of the honeycomb core with the homodromous S-shaped reinforced structures are the same as the plain unit cell in the plastic collapse mode, it can be seen that the plain honeycomb core has localized unit cell damage, with the increase of displacement, it expands to the entire core rapidly. Due to the change of the load-transfer path of the homodromous S-shaped reinforced structure, the honeycomb core with the homodromous S-shaped reinforced structure has an obvious shear failure, which guides the direction and position of the plastic collapse of the unit cells, changes the expansion and correlation of the plastic collapse between the unit cells of the core, and then changes the peak load of the core.

Table 1 shows the average peak load and specific peak load comparison of the plain honeycomb core and the honeycomb core with heterodromous S-shaped reinforced structures at the loading speed of 1 mm/min, the average peak load of the honeycomb core with heterodromous S-shaped reinforced structures is 144.84 N, which is 86.12% higher than the 77.82 N of the plain honeycomb core. The average specific peak load of the honeycomb core with heterodromous S-shaped reinforced structures is 6.72 N/g, which is 53.08% higher than that of the plain honeycomb core at 4.39 N/g.

TABLE 1

| | Aluminum | |
|---|---|---|
| | plain | Aluminum honeycomb core |
| | honeycomb | with heterodromous S-shaped |
| Core type | core | reinforced structures |
| Average peak load (N) | 77.82 | 144.84 |
| Percentage increase in | — | 86.12% |
| average peak load | | |
| Average specific peak | 4.39 | 6.72 |
| load (N/g) | | |
| Average increase | — | 53.08% |
| percentage than peak load | | |

Table 2 shows the average peak load and specific peak load comparison of the plain honeycomb core and the honeycomb core with homodromous S-shaped reinforced structures at the loading speed of 1 mm/min, the average peak load of the honeycomb core with homodromous S-shaped reinforced structures is 100.50 N, which is increased by −0.68% compared with 77.82 N of the plain honeycomb core. The average specific peak load of the honeycomb core with homodromous S-shaped reinforced structures is 4.36 N/g, which is −0.68% lower than that of the plain honeycomb at 4.39 N/g.

TABLE 2

| | Aluminum | |
|---|---|---|
| | plain | Aluminum honeycomb core |
| | honeycomb | with homodromous S-shaped |
| Core type | core | reinforced structures |
| Average peak load (N) | 77.82 | 100.50 |
| Percentage increase in | — | 29.14% |
| average ultimate load | | |
| Average specific peak | 4.39 | 4.36 |
| load (N/g) | | |
| Average increase | — | −0.68% |
| percentage than peak load | | |

It can be seen from the above that the honeycomb core with S-shaped reinforced structures can change the bearing capacity of the core by changing the number and direction of the S-shaped reinforced structure and adjusting according to different working conditions to obtain different failure modes and peak loads. The honeycomb core with S-shaped reinforced structures is closer to the opposite direction of the two neighboring S-shaped reinforced structures, and the failure mode tends to be a progressive failure, and the peak load is significantly higher than that of the plain honeycomb core. When the two neighboring S-shaped reinforced structures are closer to the same direction, the failure mode tends to the overall shear failure, and the specific peak load is lower than that of the plain honeycomb core.

The honeycomb core with S-shaped reinforced structures of the invention performs secondary processing on the plain honeycomb so that some cells in the honeycomb core become cells with S-shaped reinforced structures. This structure guides the load-transfer path effectively by controlling the rotation of S-shaped reinforced cells, it changes the position of plastic collapse in the structure, and finally changes the peak load of the core. Under different working conditions, the design of the arrangement of S-shaped reinforced structures can make the core produce different peak loads, the peak load of the honeycomb core with S-shaped reinforced structures has a designability that can meet different engineering application requirements. In addition, the failure mode of the original plain core is improved, the honeycomb core with S-shaped reinforced structure is destroyed column by column, so that the core can be controlled and orderly destroyed, and the failure mode of the original plain core is improved. When it is used as the core of the sandwich structure, the interface performance between the core and the panel can be improved, and the mechanical bearing performance of the honeycomb sandwich panel can be improved. When the honeycomb core with S-shaped reinforced structure is used as the core of the sandwich structure, the core can be controlled and orderly destroyed, thereby significantly improving the energy absorption performance of the sandwich panel, the honeycomb core with S-shaped reinforced structures is directly flattened based on the plain honeycomb core, which has low requirements for processing equipment, the processing technology is simple, the connection between the reinforced structure and the core after processing is good, and the structural defects are few.

The embodiment of the invention is given for illustration and description, and it is not exhaustive or used to limit the invention to the disclosed form, many other modifications and changes are semblable to ordinary technicians in this field. The selection and description of the embodiment present the principle and practical application of the invention in a better way and enable ordinary technicians in this field to understand the invention and design various embodiments with various modifications suitable for specific purposes.

What is claimed is:

1. A honeycomb core with S-shaped reinforced structures, comprising cylindrical unit cells arranged in a honeycomb shape and with a polygonal cross section, wherein
the cylindrical unit cells are divided into plain unit cells and S-shaped reinforced unit cells,
an inner cavity of each of the plain unit cells is hollow, and
an inner cavity of each of the S-shaped reinforced unit cells is equipped with an S-shaped reinforced structure, wherein a cross section of the S-shaped reinforced structure is S-shaped and the inner cavity of each of the S-shaped reinforced unit cells is divided into two halves on average.

2. The honeycomb core according to claim 1, wherein each of the S-shaped reinforced unit cells is made by flattening two plain units through a pinch extrusion process.

3. The honeycomb core according to claim 1, wherein each of the S-shaped reinforced unit cells is fabricated by an integrated molding process.

4. The honeycomb core according to claim 1, wherein at least one of the plain unit cells is set between two S-shaped reinforced unit cells.

5. The honeycomb core according to claim 1, wherein the S-shaped reinforced unit cells are in multiple columns, and each column contains multiple S-shaped reinforced unit cells, the S-shaped reinforced structure of the S-shaped reinforced unit cells of the same column has a same S-shaped direction, and the S-shaped reinforced structure of neighboring two columns has a same or opposite S-shaped direction.

6. The honeycomb core according to claim 5, wherein a number of S-shaped reinforced unit cells accounts for 10%-50% of a total number of cylindrical unit cells.

7. The honeycomb core according to claim 1, wherein a cross section of each of the cylindrical unit cells is hexagonal.

8. The honeycomb core according to claim 1, wherein a material of the cylindrical unit cells is metal, carbon fiber or aramid paper.

9. The honeycomb core according to claim 1, wherein each of the cylindrical unit cells has a diameter of 2 mm-26 mm, a wall thickness of 0.04 mm-0.1 mm, and a height of 2 mm-590 mm.

10. The honeycomb core according to claim 1, wherein a thickness of the S-shaped reinforced structure is twice a wall thickness of each of the cylindrical unit cells.
